(19) United States
(12) Patent Application Publication
(10) Pub. No.: US 2010/0035062 A1
(43) Pub. Date: Feb. 11, 2010

(54) MANUFACTURING METHODS OF MAGNESIUM-VANADIUM COMPOSITE OXIDE NANOPARTICLE AND MAGNESIUM-VANADIUM COMPOSITE OXIDE NANOPARTICLE MANUFACTURED BY THE SAME

(76) Inventors: Chul Tack LIM, Suwon (KR); Chang Hwan Choi, Seongnam (KR); Byoung Jin Chun, Suwon (KR); Jin Hyuck Yang, Suwon (KR)

Correspondence Address: MCDERMOTT WILL & EMERY LLP, 600 13TH STREET, N.W., WASHINGTON, DC, 20005-3096, US

(21) Appl. No.: 12/402,725

(22) Filed: Mar. 12, 2009

(30) Foreign Application Priority Data
Aug. 5, 2008 (KR) 10-2008-0076446

(51) Int. Cl. B32B 15/08; B05D 3/02

(52) U.S. Cl. 428/407; 427/227; 977/773

(57) ABSTRACT

Provided are manufacturing methods of a magnesium-vanadium composite oxide nanoparticle that make it possible to manufacture a composite oxide of several tens of nanometers in size containing two kinds of metals, and also to accurately design and manufacture a product material having a desired ratio between the metals, and a magnesium-vanadium composite oxide nanoparticle manufactured by the manufacturing methods. In the manufacturing method, a solution containing a magnesium salt and a vanadium salt is prepared. An organic polymer having nano-sized pores is dipped in the prepared solution, and is then heated until the organic polymer is calcined, thereby manufacturing a magnesium-vanadium composite oxide nanoparticle.

### CROSS-REFERENCE TO RELATED APPLICATIONS

This application claims the priority of Korean Patent Application No. 10-2008-0076446 filed on Aug. 5, 2008, in the Korean Intellectual Property Office, the disclosure of which is incorporated herein by reference.

### BACKGROUND OF THE INVENTION

1. Field of the Invention

The present invention relates to manufacturing methods of a magnesium-vanadium composite oxide nanoparticle and a magnesium-vanadium composite oxide nanoparticle manufactured by the same, and more particularly, to manufacturing methods of a magnesium-vanadium composite oxide nanoparticle that make it possible to manufacture a composite oxide of several tens of nanometers in size containing two kinds of metals, and also to accurately design and manufacture a product material having a desired ratio between the metals, and a magnesium-vanadium composite oxide nanoparticle manufactured by the manufacturing methods.

2. Description of the Related Art

Recently, in line with the tendency toward compactness, thinning, and higher capacity of products, ultra-fining process of a raw material itself is also considered important, and acts as an essential technology in the manufacture of products.

For instance, in the manufacture of a multi layer ceramic capacitor (MLCC), to increase capacitance, it is necessary to finely make not only barium titanate (BaTiO₃) used as a main ingredient of a dielectric but also additives (mainly, metal oxides) affecting chip characteristics of the MLCC, then to uniformly disperse them as primary particles, and to stably maintain their states.

An average diameter of BaTiO₃ typically used for an ultra-thin and ultra-high capacity MLCC is about 150 nm. In order to ideally coat the surface of BaTiO₃ by adding the additive, to maintain composition uniformity of a dielectric film and an internal electrode for obtaining ultra-thinness and high reliability, and to restrain pores from occurring inside the dielectric, it is necessary to accomplish the fineness of additive powder and a main ingredient of a dielectric, and the dispersion stabilization.

As an MLCC additive, a magnesium oxide functions to prevent an abnormal grain growth of a matrix particle, and a vanadium oxide serves as a low melting point liquid phase sintering promoter. In spite of the fact that required amounts of the magnesium oxide and the vanadium oxide are very small because they are used as the additive, they are essential additives. Therefore, sizes and shapes of the magnesium oxide and vanadium oxide particles may have a great effect on the overall performance and quality of products.

A top down method is generally used to manufacture the magnesium oxide or the vanadium oxide. In this method, a metal oxide precursor of which a primary average diameter is in the range of 100 nm to 2,000 nm, is prepared in form of slurry using a disperser, and then milled into smaller particles. In other words, the top down method utilizes a process of milling powders having a particle size greater than a target particle size into smaller-sized particles.

According to the top down method, there is a great possibility that particles of several nanometers in size can be attained in case that the metal oxide precursor is small in particle size, but it is problematic in that a precursor material is too expensive. If the precursor material having a large particle size is used, it is not easy to mill the large-sized particles into small-sized particles. Moreover, even after milling the particles, the particle obtained after the milling may not have a desirable shape or the particles agglomerate with each other, which has been considered as a serious problem in the top down method.

To overcome the aforesaid problems, an aerosol method for manufacturing a magnesium oxide or a vanadium oxide or a method of decomposing a precursor material using microwave plasma has been proposed. However, theses methods are also kinds of top down methods, and thus make use of the same technical principle that a large-sized particle should be further broken into a small-sized one, which leads to a limitation in adjustment of particle size.

### SUMMARY OF THE INVENTION

An aspect of the present invention provides manufacturing methods of a magnesium-vanadium composite oxide nanoparticle that make it possible to manufacture a composite oxide of several tens of nanometers in size containing two kinds of metals, and also to accurately design and manufacture a product material having a desired ratio between the metals, and a magnesium-vanadium composite oxide nanoparticle manufactured by the manufacturing methods.

Another aspect of the present invention provides a method of manufacturing a magnesium-vanadium composite oxide nanoparticle, including: preparing a magnesium salt/vanadium salt mixed solution where a magnesium salt and a vanadium salt are dissolved in a solvent; dipping an organic polymer having nano-sized pores in the magnesium salt/vanadium salt mixed solution; and heating the organic polymer dipped in the magnesium salt/vanadium salt mixed solution until the organic polymer is calcined. Herein, the solvent is water, and thus the magnesium salt/vanadium salt mixed solution may an aqueous solution.

A concentration of the magnesium salt/vanadium salt mixed solution may range from approximately 15 wt % to approximately 25 wt %. After the organic polymer is dipped in the magnesium salt/vanadium salt mixed solution, a heating process may be performed to calcine the organic polymer. The heating process may be performed at a temperature ranging from approximately 400° C. to approximately 900° C. The heating of the organic polymer may be performed through two heating processes. For example, one heating process may be performed at approximately 400° C. for approximately for approximately 2 hours, and the other heating process may be performed at approximately 700° C. for approximately 2 hours.

A pore size of the organic polymer may be a nanometer level, and may be in the range of approximately 1 nm to approximately 9 nm. The magnesium-vanadium composite oxide nanoparticle may have a size ranging from approximately 20 nm to approximately 40 nm.

The method of manufacturing a magnesium-vanadium composite oxide nanoparticle may further include, before the heating of the organic polymer dipped in the magnesium salt/vanadium salt mixed solution, drying the organic polymer dipped in the magnesium salt/vanadium salt mixed solution.

The method of manufacturing a magnesium-vanadium composite oxide nanoparticle may further include after the heating of the dipped organic polymer, milling a heating residue.

According to another aspect of the present invention, there is provided a magnesium-vanadium composite oxide nanoparticle manufactured by the methods.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates magnesium-vanadium composite oxide nanoparticles trapped in pores of an organic polymer in an embodiment of the present invention;

FIG. 2 is a graph showing a particle size analysis result according to number of magnesium-vanadium composite oxide nanoparticles manufactured by one embodiment of the present invention;

FIG. 3 illustrates an energy dispersive spectroscopy (EDS) analysis result of magnesium-vanadium composite oxide nanoparticles manufactured by one embodiment of the present invention;

FIG. 4 is a graph showing a composition analysis result for the region 1 in the EDS analysis result of FIG. 3;

FIG. 5 is a graph showing a composition analysis result for the region 2 in the EDS analysis result of FIG. 3; and

FIG. 6 is a graph showing a magnesium-to-vanadium molar ratio of a raw material versus a magnesium-to-vanadium molar ratio of a product material in magnesium-vanadium composite oxide nanoparticles manufactured by one embodiment of the present invention.

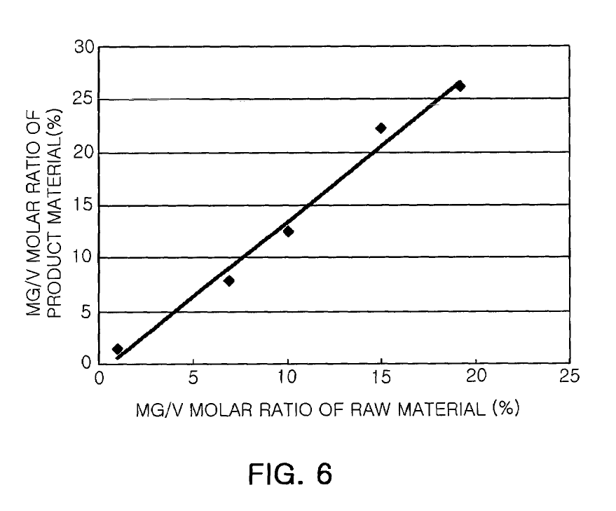

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

A method of manufacturing a magnesium-vanadium composite oxide nanoparticle, includes: preparing a magnesium salt/vanadium salt mixed solution where a magnesium salt and a vanadium salt are dissolved in a solvent.; dipping an organic polymer having nano-sized pores in the magnesium salt/vanadium salt mixed solution; and heating the organic polymer dipped in the magnesium salt/vanadium salt mixed solution until the organic polymer is calcined.

To manufacture the magnesium-vanadium composite oxide, a solution containing a magnesium salt and a vanadium salt (hereinafter, referred to as magnesium salt/vanadium salt mixed solution) is prepared first. The magnesium salt/vanadium salt mixed solution is not specifically limited, but should be a solution allowing an organic polymer to be dipped therein and also allowing the magnesium salt and the vanadium salt to be oxidized at a calcination temperature of the organic polymer to become a magnesium-vanadium composite oxide.

The solvent may be water or organic solvent. The concentration of the solution is determined in consideration of pore characteristics of the organic polymer to be immersed. For example, the concentration of the magnesium salt/vanadium salt mixed solution may be in the range of approximately 15 wt % to approximately 25 wt %. If the concentration is less than approximately 15 wt %, amounts of the magnesium salt and the vanadium salt acting as precursor materials of the magnesium-vanadium composite oxide are too small, which may cause yield of a final product, i.e., magnesium-vanadium salt composite oxide to be excessively low. On the contrary, if the concentration exceeds approximately 25 wt %, there occurs an unbalance between limited number of pores in the organic polymer and number of nanoparticles to be trapped therein, so that the nanoparticles may agglomerate with each other.

When the magnesium salt/vanadium salt mixed solution is prepared, the organic polymer having nano-sized pores is dipped into the magnesium salt/vanadium salt mixed solution. For example, the organic polymer may have pores with predetermined size, like a pulp-type fiber texture. The organic polymer available in the embodiment of the present invention may be formed to have a particle size of a nanometer level because the organic polymer has the nano-sized pores. For instance, the organic polymer may be cellulose expressed as a chemical formula of (C₆H₁₀O₆)ₙ, which is a fibrin of a plant. When the cellulose is heated, carbon dioxide (CO₂) and water (H₂O) are produced.

In the term of ‘nano-sized pore’, the term ‘nano-size’ means a size of several nanometers. Since substances trapped in the pores are the magnesium salt and the vanadium salt, which are precursor materials of the magnesium-vanadium composite oxide, the magnesium salt and the vanadium salt are trapped in the pores of several nanometers in size in the organic polymer before they are changed into the magnesium-vanadium composite oxide. After being trapped in the pores of the organic polymer, they are changed into the magnesium-vanadium composite oxide. Therefore, the pore of the organic polymer may have a size ranging from approximately 1 nm to approximately 9 nm.

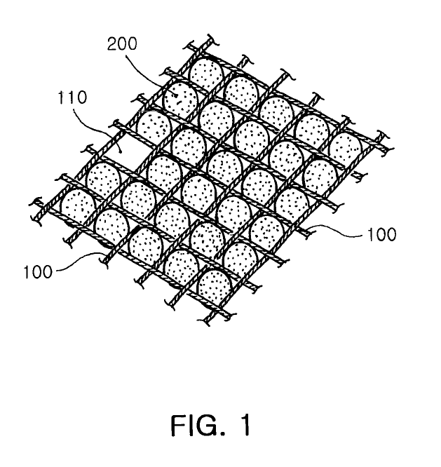

FIG. 1 illustrates magnesium or vanadium salt particles 200 respectively trapped in pores 110 of an organic polymer 100 in an embodiment of the present invention. The magnesium or vanadium salt particles 200 are respectively trapped in the nano-sized pores 110 of the organic polymer 100, and thus are also several nanometers in size.

Since the magnesium or vanadium salt particles 200 are trapped in the pores 110 of the organic polymer 100, respectively, they do not agglomerate with each other during the reaction. The precursor itself exists in the form of a nano-sized particle, and thus a reaction product, i.e., the magnesium-vanadium composite oxide of several nanometers in size can exist although the precursor is changed into the magnesium-vanadium composite oxide. Also, it is possible to control a shape of the magnesium-vanadium composite oxide nanoparticle such that the magnesium-vanadium composite oxide particle has a uniform shape.

The magnesium-vanadium oxide nanoparticle manufactured by the manufacturing method of a magnesium-vanadium composite oxide nanoparticle has a size of several tens of nanometers. For example, the particle size of the magnesium-vanadium composite oxide may be in the range of approximately 20 nm to approximately 40 nm.

The organic polymer is dipped in the magnesium salt/vanadium salt mixed solution, and then heated. As described above, the organic polymer, for example, (C₆H₁₀O₆)ₙ, is heated to change into carbon dioxide (CO₂) and water (H₂O). Accordingly, the organic polymer can be removed through heating process.

After the organic polymer is dipped in the solution containing the magnesium salt and the vanadium salt, a heating process is performed at a temperature ranging from approximately 400° C. to approximately 900° C. to calcine the organic polymer. The heating process may be performed twice. That is, two heating processes may be performed. For example, a first heating process may be performed at approximately 400° C. for approximately 2 hours, and a second heating process may be performed at approximately 700° C. for approximately 2 hours.

Before the heating of the organic polymer dipped in the magnesium salt/vanadium salt mixed solution, the manufacturing method of the magnesium-vanadium composite oxide nanoparticle according to the embodiment of the present invention may further include drying the organic polymer dipped in the magnesium salt/vanadium salt mixed solution. In case where excessive amounts of the magnesium salt and the vanadium salt are dipped in the organic polymer dipped in the magnesium salt/vanadium salt mixed solution, magnesium and vanadium crystals or magnesium and vanadium salts having a size greater than a nanometer size may be produced on the surface of the organic polymer. Therefore, the excessive amount of the magnesium salt/vanadium salt mixed solution may be removed using a drying process or other removal processes.

The manufacturing method of the magnesium-vanadium composite oxide nanoparticle according to the embodiment of the present invention may further include cooling and milling the heated solution after the heating of the dipped organic polymer. Although the magnesium-vanadium composite oxide of several tens of nanometers in size is manufactured using the organic polymer, a milling process may be performed to uniformalize sizes of the manufactured nanoparticles.

After the milling process, a size analysis is performed. If the magnesium-vanadium composite oxide nanoparticle having a desired size and shape is manufactured, the milling process is stopped and the magnesium-vanadium composite oxide nanoparticle is retrieved, thus obtaining the magnesium-vanadium composite oxide nanoparticle with a desired and uniform size. At this time, since secondary particles created by clustering of primary particles may exist together, a centrifuging may be performed using a centrifugal separator to thereby obtain only the primary particles with the secondary particles removed.

According to another aspect of the present invention, there is provided a magnesium-vanadium composite oxide nanoparticle manufactured by the foregoing manufacturing methods of the magnesium-vanadium composite oxide nanoparticle. A composition ratio of the magnesium-vanadium composite oxide nanoparticle according to the present invention may be determined depending on amounts of raw materials of the magnesium salt and the vanadium salt. Further, the vanadium has any one valence of +2, +3, +4 and +5, and therefore, the composition ratio of the magnesium-vanadium composite oxide nanoparticle may vary with detailed reaction conditions and raw materials. This will be more fully described with reference to FIG. 10 later.

<Manufacture of Magnesium-Vanadium Composite Oxide Nanoparticle>

### Embodiment 1

176.1 g (6.9 mole) of magnesium salt and 16.3 g (1 mole) of vanadium salt were dissolved in 770 g of water to prepare 20 wt % aqueous solution. The organic polymer was impregnated with the prepared magnesium salt/vanadium salt mixed solution, and thereafter dried in the atmosphere for 24 hours. After being dried, the resultant was heated up to 400° C. at a temperature gradient of 5° C./min and maintained for 2 hours, and was then re-heated up to 700° C. at a temperature gradient of 5° C./min and maintained for 2 hours. Thereafter, the resultant was cooled down to a room temperature to obtain the magnesium-vanadium composite oxide nanoparticle.

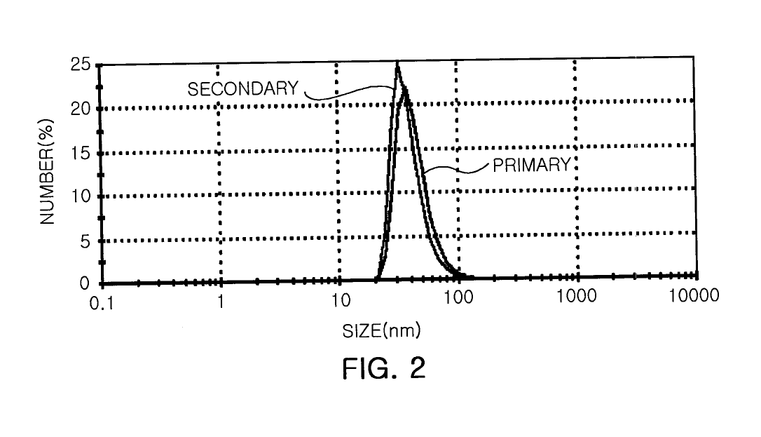

FIG. 2 is a graph showing a particle size analysis result according to number of the manufactured magnesium-vanadium composite oxide nanoparticles. The particle size analysis was performed on the same magnesium-vanadium composite oxide nanoparticle twice, and a median percentile of the particle size distribution, i.e., D50, was 35 nm. Since the 10^{th} percentile of the particle size distribution, i.e., D10 is 26 nm, the particles existing in the distribution range of 10% to 50% have a size ranging from approximately 26 nm to approximately 35 nm. Therefore, it can be observed that the magnesium-vanadium composite oxide nanoparticle having more uniform particle size was produced.

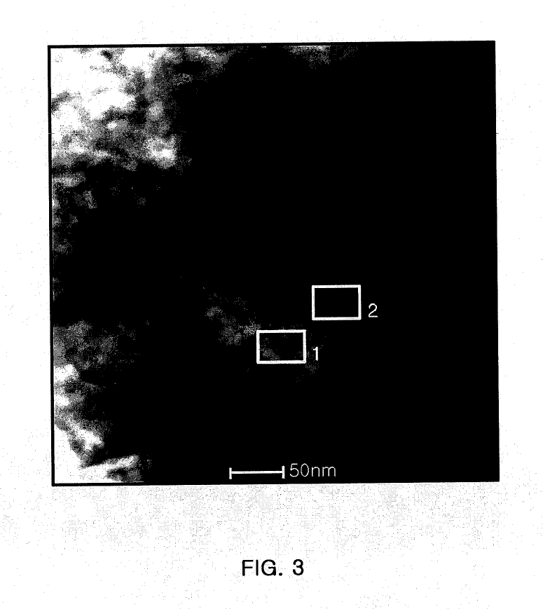

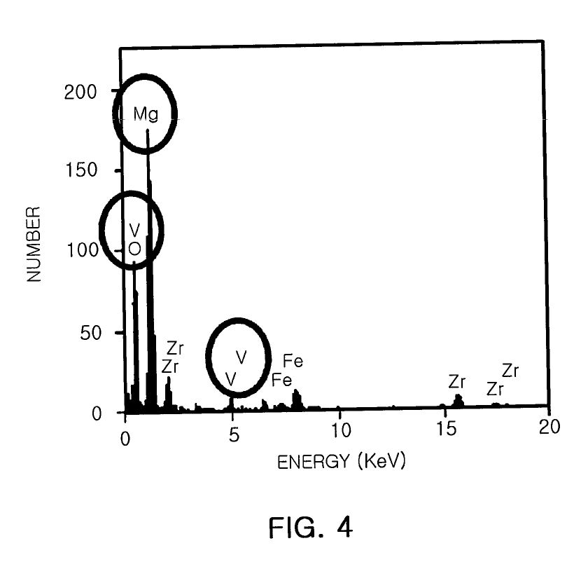

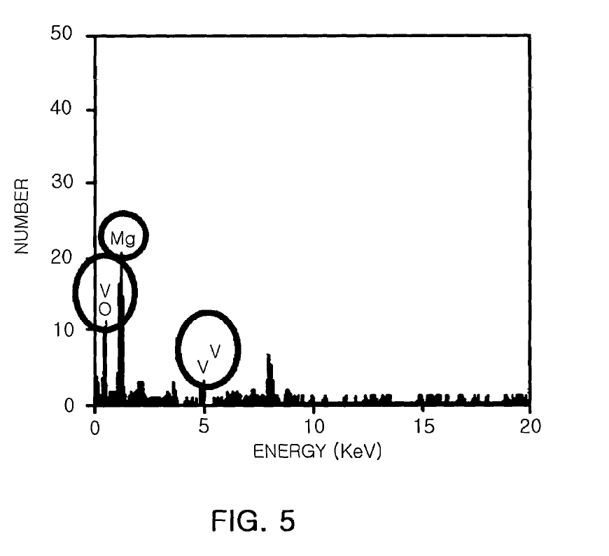

FIG. 3 illustrates an energy dispersive spectroscopy (EDS) analysis result of magnesium-vanadium composite oxide nanoparticles manufactured by one embodiment of the present invention. FIG. 4 is a graph showing a composition analysis result for the region 1 in the EDS analysis result of FIG. 3. FIG. 5 is a graph showing a composition analysis result for the region 2 in the EDS analysis result of FIG. 3.

From the EDS analysis result of FIG. 3, a composition of magnesium, vanadium and oxide can be observed. The EDS analysis was performed on the regions 1 and 2 shown in FIG. 3, of which results are illustrated in FIGS. 4 and 5, respectively.

Consequently, it can be observed that magnesium and vanadium are uniformly distributed over the magnesium-vanadium composite oxide nanoparticle manufactured by the inventive manufacturing method.

### Embodiment 2

A magnesium-vanadium composite oxide nanoparticle was prepared through the same method illustrated in the embodiment 1 except that 1 mole of magnesium salt was used.

### Embodiment 3

A magnesium-vanadium composite oxide nanoparticle was prepared through the same method illustrated in the embodiment 1 except that 10.0 mole of magnesium salt was used.

### Embodiment 4

A magnesium-vanadium composite oxide nanoparticle was prepared through the same method illustrated in the embodiment 1 except that 15.0 mole of magnesium salt was used.

### Embodiment 5

A magnesium-vanadium composite oxide nanoparticle was prepared through the same method illustrated in the embodiment 1 except that 19.2 mole of magnesium salt was used.

Following Table 1 shows raw materials used in the foregoing embodiments 1 to 5, magnesium-to-vanadium (Mg/V) molar ratios of a raw material to a product material, and a weight ratio of the product material.

TABLE 1

| | | | | Product | | | Product | |
|---|---|---|---|---|---|---|---|---|
| | Raw material | | | material | | | material | |
| | (Mole) | | | (Mole) | | | (weight) | |
| Embodiment | Mg | V | Mg/V | Mg | V | Mg/V | Mg | V |
| 1 | 6.9 | 1 | 6.9 | 1.85 | 0.236 | 7.85 | 44.9 | 12.0 |
| 2 | 1 | 1 | 1.0 | 0.907 | 0.612 | 1.48 | 21.1 | 31.2 |
| 3 | 10.0 | 1 | 10.0 | 1.97 | 0.158 | 12.46 | 47.9 | 8.06 |
| 4 | 15.0 | 1 | 15.0 | 2.14 | 0.096 | 22.28 | 52.1 | 4.90 |
| 5 | 19.2 | 1 | 19.2 | 2.23 | 0.085 | 26.17 | 54.3 | 4.35 |

FIG. 10 is a graph showing a magnesium-to-vanadium (Mg-to-V) molar ratio of a raw material versus a Mg-to-V molar ratio of a product material in magnesium-vanadium composite oxide nanoparticles of the embodiments 1 to 5. In FIG. 10, a regression equation expressing the relation between a Mg-to-V molar ratio of a raw material and a Mg-to-V molar ratio of a product material is derived, which is represented by following Eq. 1.

y=1.4292x−0.8305 (Eq. 1)

where x is the Mg-to-V molar ratio of the raw material, and y is the Mg-to-V molar ratio of the product material. The coefficient of determination (R²) is 0.9851.

Therefore, according to the manufacturing method of the magnesium-vanadium composite oxide nanoparticle in accordance with the embodiments of the present invention, it can be observed that the composition ratio of magnesium to vanadium can be designed at a design accuracy of approximately 98%.

According to the present invention, it is possible to effectively manufacture a magnesium-vanadium composite oxide nanoparticle by manufacturing a magnesium-vanadium composite oxide nanoparticle, not by separately preparing a magnesium oxide and a vanadium oxide.

Furthermore, it is possible to manufacture a magnesium-vanadium composite oxide nanoparticle of several tens of nanometers in size despite a composite oxide. In addition, a magnesium-vanadium composite oxide nanoparticle having a uniform and desired shape can be obtained by controlling the shape of the magnesium-vanadium composite oxide nanoparticle of several tens of nanometers in size.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a magnesium-vanadium composite oxide nanoparticle, the method comprising:
preparing a magnesium salt/vanadium salt mixed solution where a magnesium salt and a vanadium salt are dissolved in a solvent;
dipping an organic polymer having nano-sized pores in the magnesium salt/vanadium salt mixed solution; and
heating the organic polymer dipped in the magnesium salt/vanadium salt mixed solution until the organic polymer is calcined.

2. The method of claim 1, wherein the solvent comprises water.

3. The method of claim 1, wherein a concentration of the magnesium salt/vanadium salt mixed solution ranges from approximately 15 wt % to approximately 25 wt %.

4. The method of claim 1, wherein the heating of the organic polymer is performed at a temperature ranging from approximately 400° C. to approximately 900° C.

5. The method of claim 1, wherein the heating of the organic polymer is performed through two heating processes.

6. The method of claim 5, wherein one heating process is performed at approximately 400° C. for approximately for approximately 2 hours, and the other heating process is performed at approximately 700° C. for approximately 2 hours.

7. The method of claim 1, wherein a pore size of the organic polymer ranges from approximately 1 nm to approximately 9 nm.

8. The method of claim 1, wherein the magnesium-vanadium composite oxide nanoparticle has a size ranging from approximately 20 nm to approximately 40 nm.

9. The method of claim 1, further comprising, before the heating of the organic polymer dipped in the magnesium salt/vanadium salt mixed solution, drying the organic polymer dipped in the magnesium salt/vanadium salt mixed solution.

10. The method of claim 1, further comprising, after the heating of the dipped organic polymer, milling a heating residue.

11. A magnesium-vanadium composite oxide nanoparticle manufactured by the method of claim 1.
